(19) United States
(12) Patent Application Publication
(10) Pub. No.: US 2026/0135453 A1
(43) Pub. Date: May 14, 2026

(54) SWITCHED RELUCTANCE MOTOR COMPRISING PERMANENT MAGNETS

(71) Applicant: Sung Ryong LIM, Pocheon-si, Gyeonggi-do (KR)

(72) Inventor: Sung Ryong LIM, Pocheon-si, Gyeonggi-do (KR)

(21) Appl. No.: 19/120,701

(22) PCT Filed: Oct. 12, 2023
(86) PCT No.: PCT/KR2023/015704

§ 371 Date: Apr. 11, 2025

(30) Foreign Application Priority Data
Oct. 14, 2022 (KR) 10-2022-0131993
Oct. 11, 2023 (KR) 10-2023-0135220

(51) Int. Cl. H02K 19/06

(52) U.S. Cl. CPC H02K 19/06

(57) ABSTRACT

The present disclosure relates to a switched reluctance motor including permanent magnets. More particularly, it relates to a switched reluctance motor including a plurality of permanent magnets, where permanent magnets [stator-PMs] and coil windings are arranged in a stator. The coil windings use an alternate teeth winding configuration, and the magnetic flux directions of the coil windings and the permanent magnets are opposite. Magnetic flux path guides are included such that, when no current flows, the magnetic flux of the permanent magnets circulates only within the stator, minimizing flux through the air gap and suppressing cogging torque. When current is applied, the N-pole flux induced by the windings repels the N-pole flux of the permanent magnets, forcing the flux into the air gap. There, the fluxes combine, increasing electromagnetic force and torque, while improving efficiency and suppressing cogging torque and induced voltage despite the presence of the permanent magnets.

### BACKGROUND

### Technical Field

The present disclosure relates to a switched reluctance motor including permanent magnets, and more particularly, to a switched reluctance motor utilizing permanent magnets, in which a magnetic flux path guide is used to adjust a magnetic path formed by the permanent magnets, thereby preventing cogging torque from being generated while increasing torque and efficiency of the motor.

### Description of the Related Art

A switched reluctance motor (SRM) is a type of motor that operates on the principle of reluctance torque. The SRM includes a rotor having salient poles and a stator having concentrated windings, and is characterized in that it does not have brushes or a commutator associated with motor operation. The SRM operates on the principle that a magnetic circuit is always formed in a direction in which reluctance is minimized. When current is applied to a stator coil in the SRM, a magnetic flux is established in the salient poles of the stator, and the salient poles of the rotor are aligned with the salient poles of the stator, generating torque that rotates the rotor. In this case, a direction of torque varies depending on the current applied to the motor and the position of the rotor. The switched reluctance motor has advantages in that it can withstand high rotational speeds due to its simple structure and has low rotor loss; however, there is a limitation in increasing the output density, and difficulties exist in practical use due to noise and vibration caused by torque ripple.

Cogging torque refers to torque that is generated in a motor when the salient poles of the stator are not aligned with the salient poles of the rotor while the rotor is stationary. This torque is generated due to interaction between the salient poles of the stator and the rotor and may cause vibration and noise in the motor.

In order to minimize problems caused by the cogging torque, motors including permanent magnets of the related art have employed methods, such as optimizing the design of the salient poles of the rotor and stator or controlling the current waveform applied to stator windings. However, these methods have several problems, such as significantly increasing manufacturing costs and failing to completely eliminate cogging torque.

Therefore, there is a demand in the related art for a switched reluctance motor that completely eliminates cogging torque through a low-cost design.

Korean Patent No. 1604637 discloses a vacuum motor with generator.

### BRIEF SUMMARY

### Technical Problem

The present disclosure has been made in an effort to provide a switched reluctance motor configured to prevent cogging torque from being generated. For example, the present disclosure has been made in an effort to provide a switched reluctance motor that prevents cogging torque from being generated by adjusting magnetic paths formed by permanent magnets and a plurality of permanent magnet modules coupled to a stator.

Note that the technical problem to be solved by the present disclosure is not limited to the above-described problem, and various technical problems may be included within the scope apparent to one skilled in the art from the following description.

### Technical Solution

A switched reluctance motor according to an exemplary embodiment of the present disclosure for achieving the above-described object is disclosed. The switched reluctance motor includes a stator including a plurality of excitation modules, and a rotor configured to rotate about a rotational axis by magnetically interacting with the stator, wherein the excitation modules each include one or more permanent magnet modules configured to suppress cogging torque of the motor.

In an exemplary embodiment of the present disclosure, the rotor may rotate about the rotational axis inside the stator.

In an exemplary embodiment of the present disclosure, each of the permanent magnet (Stator-PM) modules may be located at a center of a coil wound around the excitation module and may include one or more permanent magnets and one or more magnetic flux path guides coupled to the permanent magnets.

In an exemplary embodiment of the present disclosure, the permanent magnet modules may be arranged at predetermined intervals along a circumferential direction of the stator.

In an exemplary embodiment of the present disclosure, each of the excitation modules may include a plurality of first salient poles arranged along a circumferential direction of the stator, one or more first slots located between the first salient poles, and a coil wound around the plurality of first salient poles.

In an exemplary embodiment of the present disclosure, an interval between the excitation modules may be equal to a width of the first salient pole, and a width of the first slot may be equal to or less than twice the width of the first salient pole.

In an exemplary embodiment of the present disclosure, the rotor may include a plurality of second salient poles, and a width of each of the second salient poles may be equal to or greater than a width of each of the first salient poles.

In an exemplary embodiment of the present disclosure, current applied to the coil may be a current applied in a direction in which a magnetic field induced by the current reinforces a magnetic field around the coil generated by the permanent magnet module.

In an exemplary embodiment of the present disclosure, the stator may further include a flux barrier between the excitation modules.

In an exemplary embodiment of the present disclosure, the rotor may rotate about the rotational axis outside the stator.

In an exemplary embodiment of the present disclosure, the stator may include a plurality of stator modules having different phases, and the plurality of stator modules may be located on the same rotational axis.

A motor structure according to an exemplary embodiment of the present disclosure for achieving the above-described object is disclosed. The motor structure includes a stator including a plurality of excitation modules, and a rotor configured to rotate about a rotational axis by magnetically interacting with the stator, wherein the excitation modules may each include one or more permanent magnet modules configured to suppress cogging torque of the motor.

### Advantageous Effects

The present disclosure provides a switched reluctance motor that prevents cogging torque from being generated. For example, the present disclosure may provide a switched reluctance motor including a plurality of permanent magnet modules coupled to a stator, in which stator permanent magnets (Stator-PMs) form magnetic flux only inside the stator by means of magnetic flux path guides, so that cogging torque is not generated and high torque and high output density are achieved.

In addition, in the switched reluctance motor of the present disclosure, coil windings and permanent magnets (Stator-PMs) are arranged in the stator, the coil windings are arranged in an alternate teeth winding configuration, and magnetic flux path guides are added to the permanent magnets, so that no generated voltage is present and energy consumption is reduced during field-weakening control of the motor, and the risk of demagnetization due to an external magnetic field is further reduced.

In addition, the switched reluctance motor of the present disclosure has no bearing current compared to methods of the related art. In the case of rotor permanent magnets (Rotor-PMs) of the related art, disassembly, assembly, and bearing replacement are difficult due to a strong attractive force between a magnetic field generated by the permanent magnets and a stator core (ferromagnetic material). In contrast, the stator permanent magnets (Stator-PMs) of the present disclosure have no attractive force, making disassembly, assembly, and bearing replacement easier.

Note that the effects of the present disclosure are not limited to the above-described effects, and various effects may be included within the scope apparent to one skilled in the art from the following description.

### DESCRIPTION OF THE SEVERAL VIEWS OF THE DRAWINGS

FIG. 1 is a three-dimensional view of a switched reluctance motor according to an exemplary embodiment of the present disclosure.

FIG. 2 is a three-dimensional view showing a rotor and a stator included in the switched reluctance motor according to an exemplary embodiment of the present disclosure.

FIG. 3A is a plan view showing the switched reluctance motor according to an exemplary embodiment of the present disclosure.

FIG. 3B is a plan view showing an excitation module of the switched reluctance motor according to an exemplary embodiment of the present disclosure.

FIG. 4 is a plan view showing the switched reluctance motor according to an exemplary embodiment of the present disclosure and a coil.

FIG. 5 is a plan view showing the switched reluctance motor according to an exemplary embodiment of the present disclosure and a direction of current applied to the motor.

FIG. 6 is a plan view showing a magnetic field formed by an excitation module and a magnet of the switched reluctance motor when no current is applied to the excitation module according to an exemplary embodiment of the present disclosure.

FIG. 7 is a plan view showing a magnetic field formed by a rotor excitation module and a magnet of the switched reluctance motor when current is applied to the excitation module according to an exemplary embodiment of the present disclosure.

FIG. 8 is a plan view showing a magnetic field formed by a rotor excitation module and a magnet of the switched reluctance motor when current is applied to the excitation module according to an exemplary embodiment of the present disclosure.

FIG. 9 is a plan view showing a magnetic field formed throughout the switched reluctance motor when current is applied to the excitation module according to an exemplary embodiment of the present disclosure.

FIG. 10 is a three-dimensional view of a switched reluctance motor in which a rotor is located outside a stator according to an exemplary embodiment of the present disclosure.

FIG. 11 is a three-dimensional view showing a rotor and a stator included in a switched reluctance motor in which the rotor is located outside the stator according to an exemplary embodiment of the present disclosure.

FIG. 12 is a plan view showing a magnetic field formed throughout the switched reluctance motor in which the rotor is located outside the stator when current is applied to the excitation module according to an exemplary embodiment of the present disclosure.

FIG. 13 is a three-dimensional view of a switched reluctance motor including a plurality of stators according to an exemplary embodiment of the present disclosure.

FIG. 14 is a three-dimensional view showing a rotor and stators included in the switched reluctance motor including the plurality of stators according to an exemplary embodiment of the present disclosure.

FIG. 15 is a plan view showing a magnetic field formed throughout a switched reluctance motor upon application of current to the switched reluctance motor and the excitation module when the permanent magnet module according to an exemplary embodiment of the present disclosure includes two permanent magnets.

FIG. 16 is a plan view showing a magnetic field formed throughout a switched reluctance motor upon application of current to the switched reluctance motor and the excitation module when the permanent magnet module according to an exemplary embodiment of the present disclosure includes four permanent magnets.

FIG. 17 is a plan view showing a magnetic field formed throughout a switched reluctance motor upon application of current to the switched reluctance motor, in which a rotor is located outside a stator, and the excitation module when the permanent magnet module according to an exemplary embodiment of the present disclosure includes two permanent magnets.

FIG. 18 is a plan view showing a magnetic field formed throughout a switched reluctance motor upon application of current to the switched reluctance motor, in which a rotor is located outside a stator, and the excitation module when the permanent magnet module according to an exemplary embodiment of the present disclosure includes four permanent magnets.

FIG. 19 is an exemplary circuit diagram of an asymmetric half-bridge converter for controlling a switched reluctance motor according to an exemplary embodiment of the present disclosure.

### DETAILED DESCRIPTION

Hereinafter, a ‘switched reluctance motor including permanent magnets’ according to the present disclosure will be described in detail with reference to the accompanying drawings. The exemplary embodiments described below are provided to enable those skilled in the art to easily understand the technical idea of the present disclosure, and thus the present disclosure is not limited thereto. In addition, matters illustrated in the accompanying drawings are schematic drawings provided to facilitate understanding of the exemplary embodiments of the present disclosure, and may differ from actual implementations.

Note that each component expressed below is only an example for implementing the present disclosure. Accordingly, other implementations of the present disclosure may employ other components without departing from the spirit and scope of the present disclosure.

Additionally, the expression ‘including’ certain components is an open-ended expression that merely indicates the presence of the stated components, and should not be construed as excluding additional components.

A switched reluctance motor according to the present disclosure may include a stator including a plurality of excitation modules, a rotor that rotates about a rotational axis by magnetically interacting with the stator, and a plurality of permanent magnet modules coupled to the stator. The plurality of permanent magnet modules coupled to the stator may each include a permanent magnet and one or more magnetic flux path guides coupled to the permanent magnet. The permanent magnet module may be located at a center of a coil wound around the switched reluctance motor.

When the permanent magnets are located in the rotor, a rotor permanent magnet (Rotor-PM) motor generates cogging torque due to an attractive force between a magnetic field generated by the permanent magnets and a stator core (ferromagnetic material).

In the switched reluctance motor according to the present disclosure, permanent magnets (Stator-PMs) are arranged at the center of the coil, coil windings are arranged in an alternate teeth winding configuration such that a magnetic flux generated by the coil windings reinforces a magnetic flux generated by the permanent magnets, magnetic flux path guides are added to the permanent magnets, so that the magnetic field generated by the permanent magnets and a magnetic field generated by the coil wound on the stator of the motor can be controlled independently. As a result, when no current flows through the coil winding, the magnetic flux of the permanent magnet is hardly generated in the air gap and the rotor and is formed only inside the stator, so that the cogging torque is suppressed. When current is applied to the coil winding, the magnetic flux generated by the applied current and the magnetic flux of the permanent magnet are added, thereby increasing the electromagnetic force. Thus, electromagnetic torque and efficiency are increased, and despite the presence of the permanent magnet, no induced voltage or cogging torque is generated.

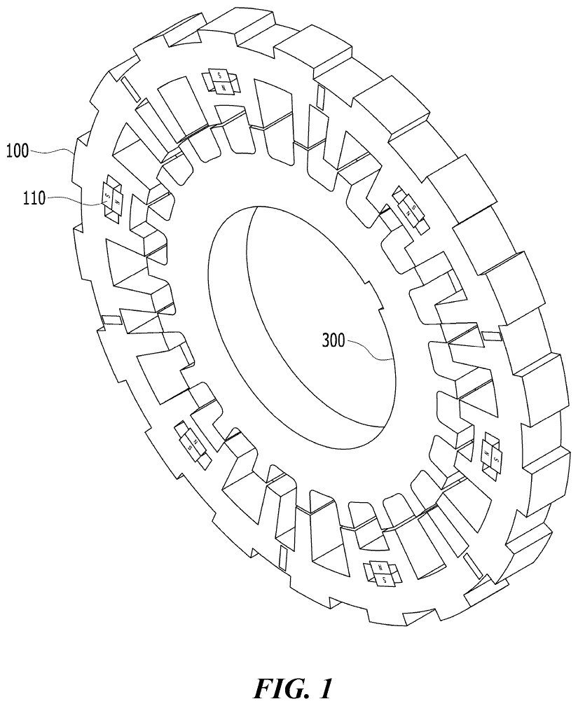

Hereinafter, exemplary embodiments of the present disclosure will be described with reference to FIGS. 1 to 19. In the present specification, various descriptions are presented for understanding of the present disclosure. However, it is apparent that these exemplary embodiments can be implemented without the specific descriptions.

Further, a term “or” intends to mean comprehensive “or” not exclusive “or,” That is, unless otherwise specified or when it is unclear in context, “X uses A or B” intends to mean one of the natural comprehensive substitutions. That is, in the case where X uses A; X uses B; or, X uses both A and B, “X uses A or B” may apply to either of these cases. Further, a term “and/or” used in the present specification shall be understood to designate and include all of the possible combinations of one or more items among the listed relevant items.

Further, a term “include” and/or “including” shall be understood as meaning that a corresponding characteristic and/or a constituent element exists. Further, it shall be understood that a term “include” and/or “including” means that the existence or an addition of one or more other characteristics, constituent elements, and/or a group thereof is not excluded. Further, unless otherwise specified or when it is unclear that a single form is indicated in context, the singular shall be construed to generally mean “one or more” in the present specification and the claims.

Further, the term “at least one of A and B” should be interpreted to mean “the case including only A,” “the case including only B,” and “the case where A and B are combined.”

The embodiments described herein are provided so that those skilled in the art to which the present disclosure pertains can make or use the disclosure. Various modifications to these embodiments will be apparent to those skilled in the art. The general principles defined herein may be applied to other embodiments without departing from the spirit or scope of the disclosure. Thus, the present disclosure is not intended to be limited to the embodiments shown herein, but is to be accorded the widest scope consistent with the principles and novel features disclosed herein.

FIG. 1 is a three-dimensional view of a switched reluctance motor according to an exemplary embodiment of the present disclosure.

The switched reluctance motor of the present disclosure may include a stator 100 and a rotor 300. The rotor 300 may be located inside the stator 100, share the same rotational axis as the stator 100, and be rotatable about the rotational axis through magnetic interaction with the stator.

Although not shown in FIG. 1, a coil to which current is applied may be coupled to the stator 100 for operation of the switched reluctance motor. In the present disclosure, the coil may be wound in an alternate teeth winding configuration, but other winding configurations for producing the same effect may be employed without limitation.

The stator 100 may include a plurality of permanent magnet modules 110. The permanent magnet module 110 may be coupled to the stator and serve to adjust a magnetic field generated by a permanent magnet according to the current applied to the coil of the stator. The permanent magnet module 110 may include a magnetic flux path guide connecting an S pole and an N pole of the permanent magnet. The magnetic flux path guide of the permanent magnet may guide the magnetic field formed by the permanent magnet to be concentrated only in a region around the permanent magnet, according to the same principle as a core included in a motor.

The permanent magnet module of the present disclosure may be located at a center of a coil wound in the motor. In this case, the center of the coil may refer to a coordinate on a straight line that is perpendicular to a plane formed by the coil wound in the motor.

By additionally arranging the permanent magnet modules and the magnetic flux path guides in the motor of the present disclosure, the induced voltage or cogging torque of the motor can be suppressed, and the power density can be increased, thereby improving the efficiency of the motor.

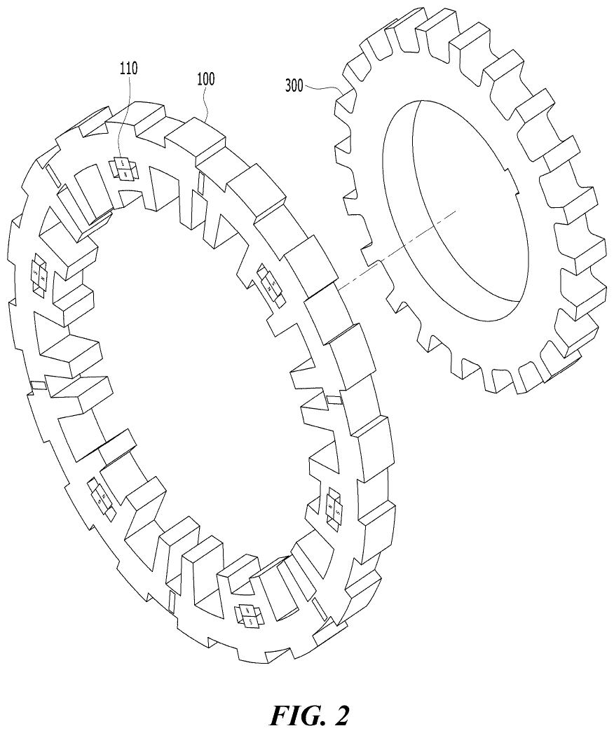

FIG. 2 is a three-dimensional view showing a rotor and a stator included in the switched reluctance motor according to an exemplary embodiment of the present disclosure.

The rotor 300 may be separated from the stator 100, and the rotor 300 and stator 100 may each include a plurality of salient poles (teeth) for magnetic interaction.

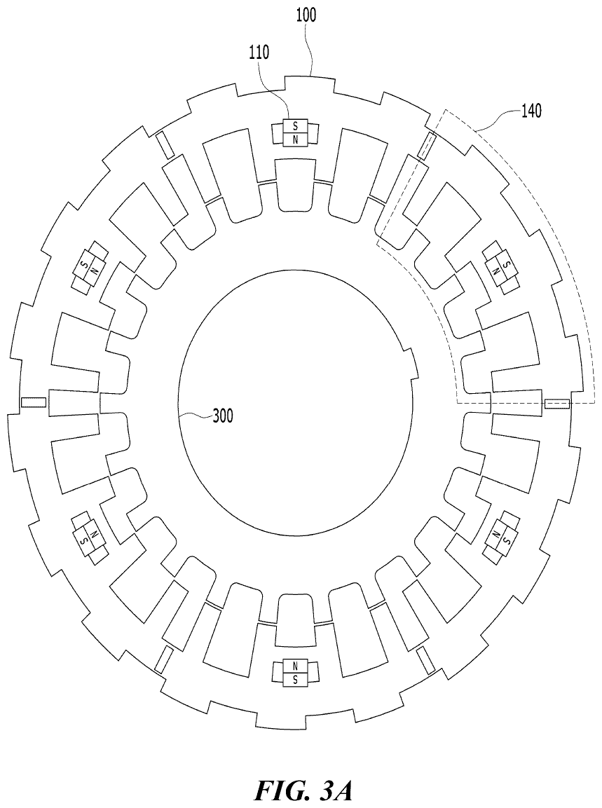

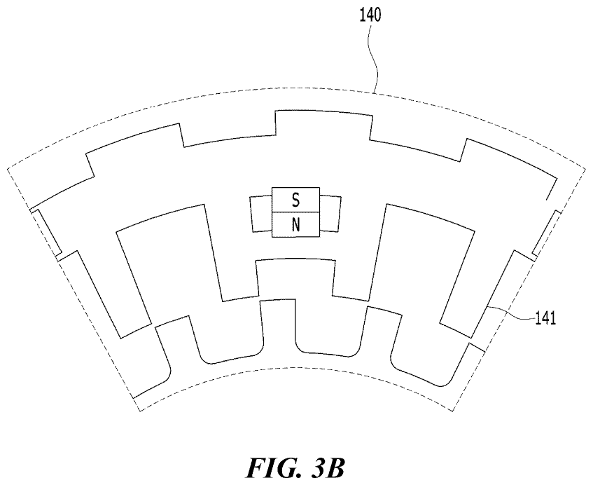

FIG. 3a is a plan view showing the switched reluctance motor according to an exemplary embodiment of the present disclosure.

The switched reluctance motor of the present disclosure may include a stator 100 and a rotor 300. The stator 100 may include an excitation module 140, which is a unit including one or more permanent magnet modules 110, and the stator may be composed of a plurality of excitation modules 140 having the same shape. The excitation modules may be arranged symmetrically about the rotational axis of the stator.

Within the stator 100, a flux barrier (not shown) may be arranged between each pair of the excitation modules 140 constituting the stator 100. The flux barrier (not shown) may serve to block mutual interference caused by the magnetic fields generated by each excitation module.

Each excitation module may include a plurality of first salient poles arranged along a circumferential direction of the stator 100 and one or more first slots located between the first salient poles. Additionally, an interval between the excitation modules may be equal to a width of the first salient pole, and a width of the first slot may be equal to or less than twice the width of the first salient pole.

Additionally, the rotor in the present disclosure may include a plurality of second salient poles. A width of each of the plurality of second salient poles included in the rotor may be equal to or greater than the width of the first salient pole.

For the exemplary embodiment shown in FIG. 3a, the stator 100 may include six excitation modules, each of which may include one permanent magnet module 110 and four salient poles.

In the present disclosure, the number of salient poles of the stator 100 may be calculated as shown in Mathematical Formula 1.

$${S}_{teeth} = 2 {M}_{p} \times P \times n \qquad Mathematical Formula 1$$

where Sₜₑₑₜₕ is the number of salient poles included in the stator, Mₚ is the number of salient poles present in one excitation module, P is the number of phases composed of excitation modules with a symmetrical structure, and n is an integer.

Additionally, in the present disclosure, a salient pole angle of the stator may be calculated as shown in Mathematical Formula 2.

$${S}_{pa} = ( 360 \div ( P \times n ) ) \div d \qquad Mathematical Formula 2$$

where Sₚₐ is an angle between the salient poles included in the stator, P is the number of phases composed of excitation modules with a symmetrical structure, n is an integer, and d is a predetermined constant.

Additionally, in the present disclosure, the number of salient poles of the rotor may be calculated as shown in Mathematical Formula 3.

$${R}_{p} = 360 \div ( {S}_{pa} \times {R}_{pd )} \qquad Mathematical Formula 3$$

where Rp is the number of salient poles included in the rotor, Sₚₐ is an angle between the salient poles included in the stator, and R_{pd} is an integer (for example, 3).

For example, in the exemplary embodiment shown in FIG. 2, the stator 100 may be composed of six excitation modules and may include 24 salient poles, in which case the rotor 300 may include 22 salient poles.

FIG. 3b is a plan view showing an excitation module of the switched reluctance motor according to an exemplary embodiment of the present disclosure.

As described above, the switched reluctance motor of the present disclosure may include a plurality of excitation modules 140, and each excitation module 140 may include a permanent magnet module and a plurality of salient poles 141. The salient poles 141 included in the excitation module 140 can contribute to rotating the rotor through magnetic interaction with the salient poles of the rotor.

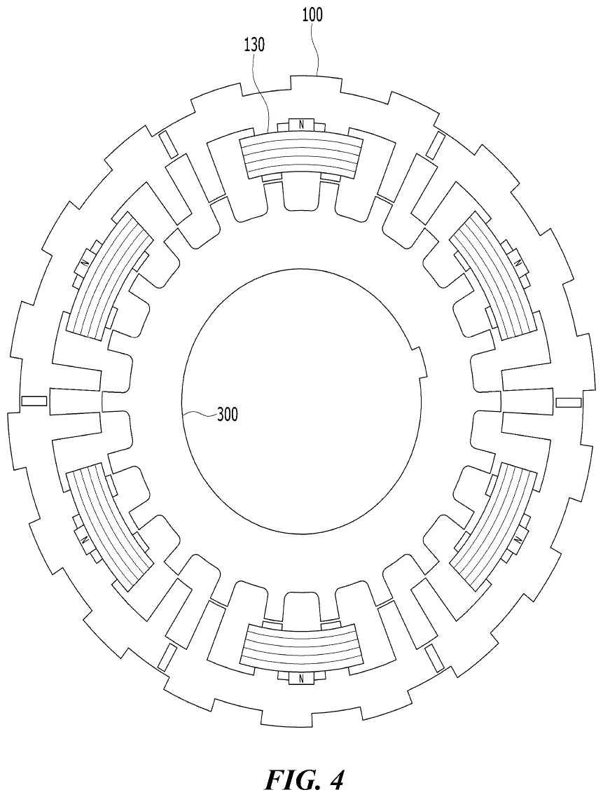

The permanent magnet module 110 of the present disclosure may be located at the center of the coil 130 wound around the excitation module of the motor, and include one or more permanent magnets and one or more magnetic flux path guides coupled to the permanent magnets. As shown in FIG. 4 described below, in the present disclosure, the coil 130 is wound via the plurality of first salient poles included in the excitation module, i.e., included in the stator, so the permanent magnet module 110 can be located between the first salient poles adjacent to each other.

One or more permanent magnets included in the permanent magnet module 110 are magnetized from the S pole to the N pole, and can be arranged such that the direction of magnetization from the S pole to the N pole within the motor is perpendicular to the direction of the circumference, and an exemplary embodiment in which the direction of magnetization from the S pole to the N pole of the permanent magnet is arranged perpendicular to the direction of the circumference is shown in FIG. 3b.

Alternatively, the plurality of permanent magnets within the permanent magnet module 110 may be arranged such that the direction of magnetization from the S pole to the N pole matches the direction of the circumference. In this case, each permanent magnet can be seen as being oriented such that the same poles face each other. That is, when one permanent magnet module 110 includes two permanent magnets, the respective permanent magnets may be arranged symmetrically, such that the N pole of the left-side permanent magnet is directed toward the outer side of the permanent magnet module, and the N pole of the right-side permanent magnet is also directed toward the outer side of the permanent magnet module.

The magnetic flux path guide included in the permanent magnet module 110 may be a conductor that connects a portion close to the S pole and a portion close to the N pole of the permanent magnet included in the permanent magnet module 110. As a result, the magnetic flux path guide included in the permanent magnet module in the present disclosure can serve to concentrate the magnetic field formed by the permanent magnet included in the permanent magnet module on the inside of the magnetic flux path guide when no current is applied to the motor, while reducing the magnetic field formed outside the permanent magnet module.

FIG. 4 is a plan view showing the switched reluctance motor according to an exemplary embodiment of the present disclosure and a coil.

The switched reluctance motor of the present disclosure includes a stator 100, and a coil 130 to which current is applied may be wound around some of the salient poles of the stator. The coil 130 can form a magnetic field around the rotor and contribute to the rotation of the rotor through magnetic interaction with the rotor, according to the basic principle of the motor.

In the present disclosure, the coil 130 wound in the switched reluctance motor may be in an alternate teeth winding configuration, a distributed winding configuration, or a single-layer winding configuration. However, it will be apparent to one skilled in the art that the coil can be wound in other well-known configurations through simple design changes, and the shape of the coil according to the present disclosure is not limited to the winding configuration exemplified above.

In an exemplary embodiment of the present disclosure, the permanent magnet module 110 may be placed at the center of the coil 130. In this case, the coil 130 may be wound in a configuration that surrounds the permanent magnet module 110.

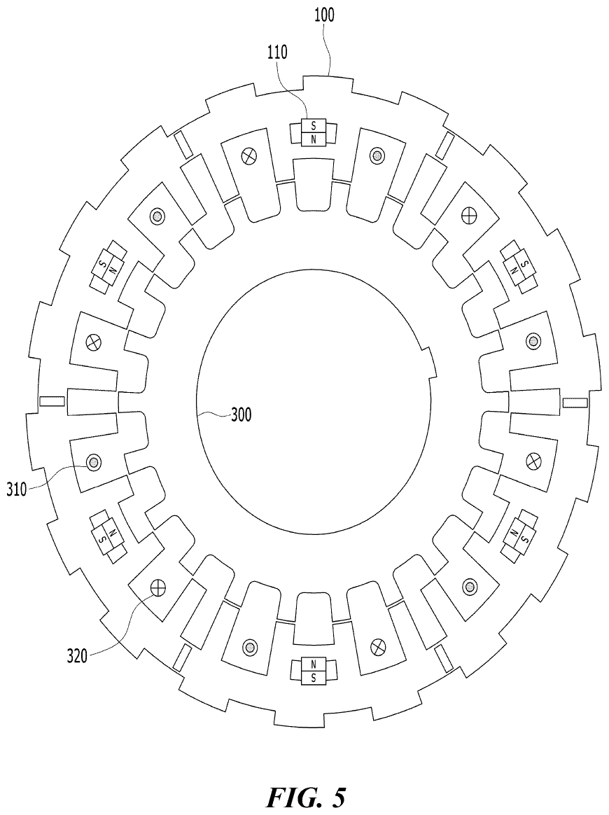

FIG. 5 is a plan view showing the switched reluctance motor according to an exemplary embodiment of the present disclosure and a direction of current applied to the motor.

In the present disclosure, current can be applied to the coil wound on the stator 100. If the current 310 applied to the coil flows in a direction coming out of the plane, it can be indicated by ‘O,’ and if the current 320 applied from the coil flows in a direction going into the plane, it can be indicated by ‘X.’ According to Ampere's law, when current flows through a coil, a magnetic field is formed around the coil, and a direction of the magnetic field forms concentric circles in a plane perpendicular to the current. In addition, the direction of the magnetic field is the same as the direction in which a right-hand screw is turned.

When the coil 130 is wound around the stator 100 as shown in FIG. 4, the current flowing through and around the stator 100 may be as shown in FIG. 5.

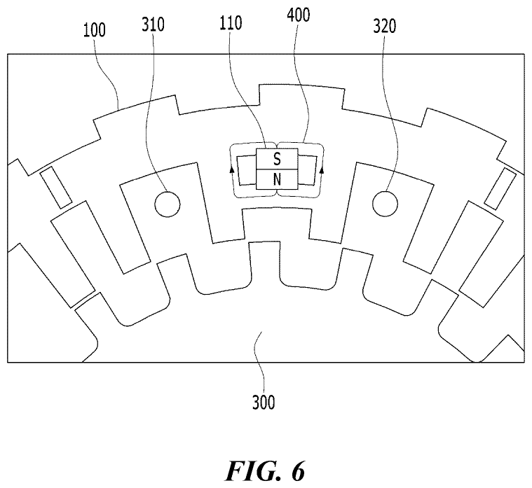

FIG. 6 is a plan view showing a magnetic field formed by an excitation module and a magnet of the switched reluctance motor when no current is applied to the excitation module according to an exemplary embodiment of the present disclosure.

When no current is applied to the excitation module, no current flows through the coil wound around the excitation module. Therefore, the magnetic field formed by the currents 310 and 320 flowing through the coil also disappears. In this case, the element that forms a magnetic field throughout the switched reluctance motor is only the permanent magnet module 110 included in the excitation module 140. The permanent magnet module 110 may be arranged such that the N pole is directed toward the center of the stator 100 and the S pole is directed toward the outer side of the stator 100. In this case, a magnetic field 400 generated by the permanent magnet is concentrated around the permanent magnet by the magnetic flux path guide of the permanent magnet included in the permanent magnet module 110, and is formed only inside the stator 100. Therefore, the rotor 300 spaced apart from the permanent magnet module 110 is not affected by the magnetic field of the permanent magnet included in the permanent magnet module 110.

In this way, when no current is applied to the excitation module, the rotor 300 may rotate or remain stationary due to inertia, and thus, no cogging torque caused by an external magnetic field is generated. In the case of a motor including permanent magnets of the related art, since the magnetic field formed by the permanent magnets always affects the rotor, during the rotation of the rotor, there is always a section where cogging torque, which is torque acting in the opposite direction to the rotation of the rotor, is generated. When the permanent magnet module 110 including the magnetic flux path guide of the permanent magnet as in the present disclosure is employed, the magnetic field affecting the rotor can be minimized, and thus the generation of cogging torque can be eliminated.

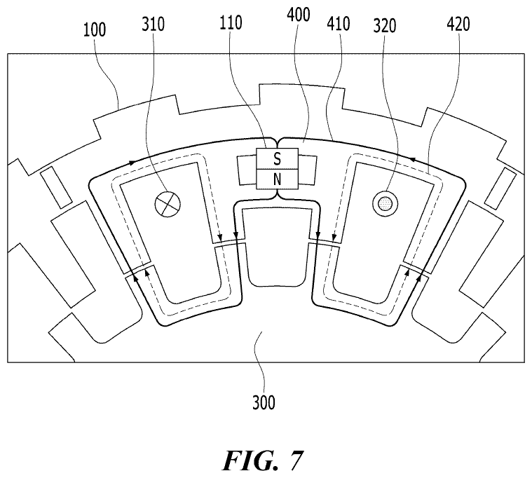

FIG. 7 is a plan view showing a magnetic field formed by a rotor excitation module and a magnet of the switched reluctance motor when current is applied to the excitation module according to an exemplary embodiment of the present disclosure.

When current is applied to the excitation module, that is, when current is applied to the coil included in the excitation module, the direction of the magnetic field induced by the current applied to the coil may be the same as the direction of the magnetic field generated around the coil by the permanent magnet module 110. Below, the interaction between the magnetic field generated by the current applied to the coil and the magnetic field generated by the permanent magnet module 110 will be described with reference to FIG. 7.

When current is applied to the excitation module, and thus, a current 310 flowing into the plane and a current 320 flowing out of the plane are formed, a clockwise magnetic field is formed around the current 310 flowing into the plane, and a counterclockwise magnetic field is formed around the current 320 flowing out of the plane. When the permanent magnet module 110 is arranged such that the N pole is directed toward the center of the stator 100 and the S pole is directed toward the outer side of the stator 100 as shown in FIG. 7, a magnetic field 410 emanating from the N pole of the permanent magnet module 110 does not directly enter the S pole along the magnetic flux path guide but interacts with a magnetic field 420 generated by the current. The magnetic field 410 emanating from the permanent magnet interacts with the magnetic field 420 generated by the current, is guided through the salient poles of the stator 100, the air gap, and the salient poles of the rotor 300, circulates around the magnetic field 420 generated by the current, and finally returns to the S pole. Additionally, when current is applied to an excitation module, the magnetic field generated by the permanent magnet and the current does not invade other excitation modules due to the air gap between the excitation modules constituting the motor.

The switched reluctance motor operates on the principle that torque is formed in the direction in which the inductance of the magnetic circuit is minimized. Therefore, in the present disclosure, when current is applied to the switched reluctance motor, torque is formed in the direction in which the salient poles of the stator 100 and the rotor 300 are aligned with each other.

At this time, the magnetic field 410 formed by the permanent magnet module and the magnetic field 420 generated by the current repel each other at each point due to repulsive forces between the same poles, thereby forcibly pushing the magnetic field from the salient poles of the stator 100 into the air gap. In the air gap, the magnetic flux generated by the permanent magnet and the magnetic flux generated by the windings are combined, resulting in an increase in magnetic field strength. Since the magnitude of the torque generated in the rotor is proportional to the strength of the magnetic field affecting the rotor, an effect of increasing the torque of the motor is obtained.

As will be described in connection with FIG. 6, the switched reluctance motor of the present disclosure may be controlled and operated by a circuit such as an asymmetric half-bridge. Specifically, by applying current to the coil at a time when the salient poles of the stator and the salient poles of the rotor are not aligned, torque can be applied in the direction in which the salient poles become aligned, i.e., in the direction of rotation. In contrast, by not applying current to the coil at a time when the salient poles of the stator and the salient poles of the rotor are aligned, the magnetic field affecting the rotor can be minimized, thereby allowing the rotor to rotate according to inertia. In this case, it is possible to prevent cogging torque from being generated, which is generally generated in the direction opposite to the direction of rotation, i.e., in the direction intended to reduce the change in magnetic field at a time when the salient poles of the stator and the salient poles of the rotor are aligned. This results in the motor operating more efficiently without being affected by cogging torque.

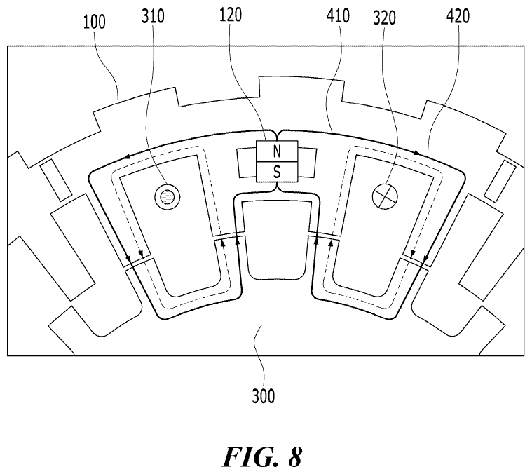

FIG. 8 is a plan view showing a magnetic field formed by a rotor excitation module and a magnet of the switched reluctance motor when current is applied to the excitation module according to an exemplary embodiment of the present disclosure.

According to an exemplary embodiment of the present disclosure, the switched reluctance motor may be implemented in such a way that the permanent magnet module 110 is arranged such that the N pole is directed toward the outer side of the stator 100 and the S pole is directed toward the inner side of the stator 100. In this case, the direction of the current applied to the coil wound around the stator 100 may be the opposite direction to the exemplary embodiment shown in FIG. 7, and the magnetic field 420 generated by the current at each point of the motor may be in a direction that reinforces the magnetic field 410 generated by the permanent magnet. Specifically, the magnetic field 410 generated by the permanent magnet starts from the N pole, spreads along the outer side of the stator, is guided in the direction of the rotor along the magnetic field 420 generated by the current, passes through the salient poles of the rotor and the stator, and finally returns to the S pole of the permanent magnet.

According to the same principle, in such an implementation, the motor can operate while excluding the influence of cogging torque, and an effect of increasing output density, torque, and efficiency of the motor are obtained.

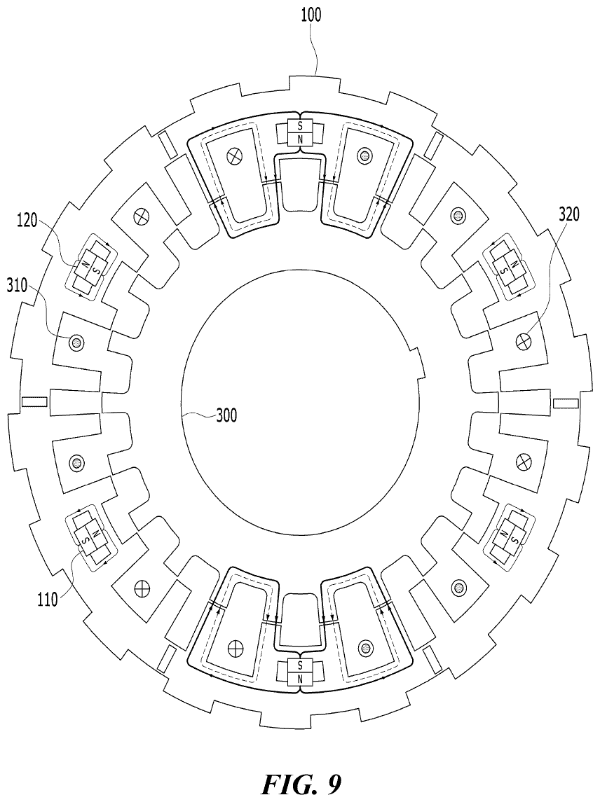

FIG. 9 is a plan view showing a magnetic field formed throughout the switched reluctance motor when current is applied to the excitation module according to an exemplary embodiment of the present disclosure.

In an exemplary embodiment of the present disclosure, the switched reluctance motor may be controlled by applying current only to the coil wound around some of the excitation modules. For example, at a specific timing for driving the switched reluctance motor, current may be applied only to the coil of an excitation module, among the excitation modules included in the stator 100, in which the salient poles thereof are aligned with or located close to the salient poles of the rotor 300. That is, in the case of FIG. 9, current may be applied only to the coil of the excitation modules in the 12 o'clock and 6 o'clock directions. In this case, in the 12 o'clock and 6 o'clock directions, torque in the direction of rotation is formed for the rotor by the magnetic field generated by the permanent magnet module and the magnetic field generated by the current, and in the excitation modules in the remaining directions, the rotor is not affected by the magnetic field by the magnetic flux path guide of the permanent magnet. Thus, the switched reluctance motor can be controlled such that torque in the direction of rotation is generated for the rotor, while cogging torque is not generated in the remaining excitation modules.

In an exemplary embodiment of the present disclosure, the switched reluctance motor may be implemented in such a way that permanent magnet modules 110 and 120 included in the plurality of excitation modules constituting the stator are arranged alternately. For example, among the excitation modules constituting the stator, the permanent magnet module of the excitation module located at the 12 o'clock position may be arranged such that the N pole is directed toward the inner side of the stator and the S pole is directed toward the outer side of the stator, and the permanent magnet modules included in the excitation modules adjacent to the excitation module located at the 12 o'clock position may be arranged such that the N pole is directed toward the outer side of the stator and the S pole is directed toward the inner side of the stator. When the directions of the permanent magnet modules are arranged alternately, the magnetic fields at the time when current is applied to the coil and at the time when no current is applied are shown in FIG. 9.

In this exemplary embodiment, as in the above-described exemplary embodiment, when current is applied, the direction of the magnetic field generated by the current and the magnetic field generated by the permanent magnet are formed in a direction that reinforces each other, and the induced magnetic field generated by the current and the magnetic field of the permanent magnet are forcibly pushed into the air gap by the repulsive force between the same poles. In the air gap, the magnetic field generated by the permanent magnet and the magnetic field generated by the current are combined, resulting in an increase in magnitude of the torque.

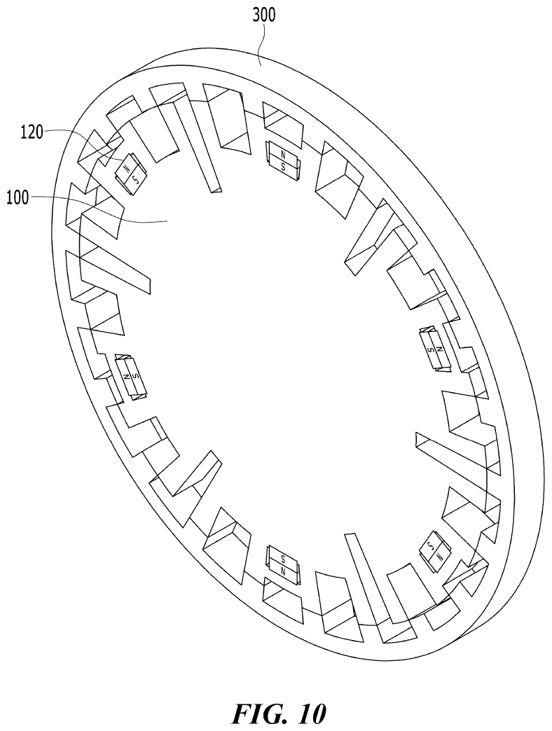

FIG. 10 is a three-dimensional view of a switched reluctance motor in which a rotor according to an exemplary embodiment of the present disclosure is located outside a stator.

In an exemplary embodiment of the present disclosure, a switched reluctance motor may be implemented in a form in which the rotor 300 is located outside the stator 100.

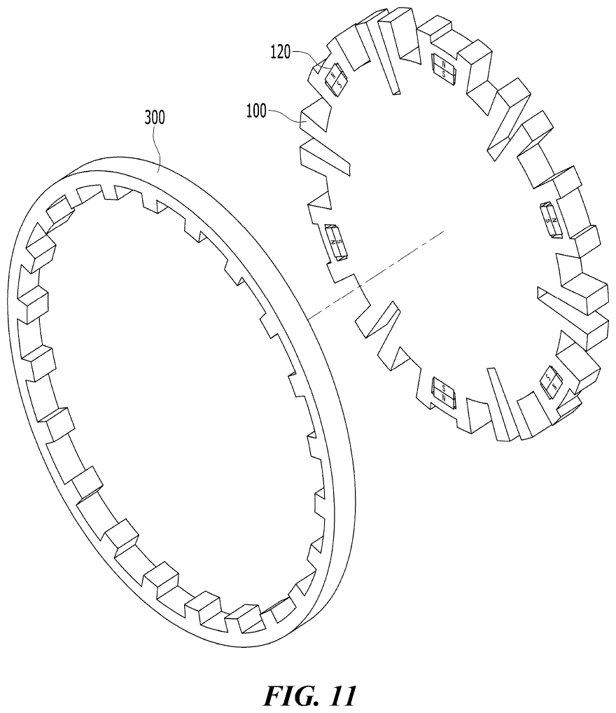

In this case, the rotor and the stator may be arranged to share the same rotational axis. A magnetic field is generated by the permanent magnet module 120 included in the stator 100 and the current applied to the coil wound around the stator 100, and torque in the direction of rotation is generated for the rotor 300 under the influence of the magnetic field. A schematic form of each component when the rotor 300 and the stator 100 are separated is shown in FIG. 11.

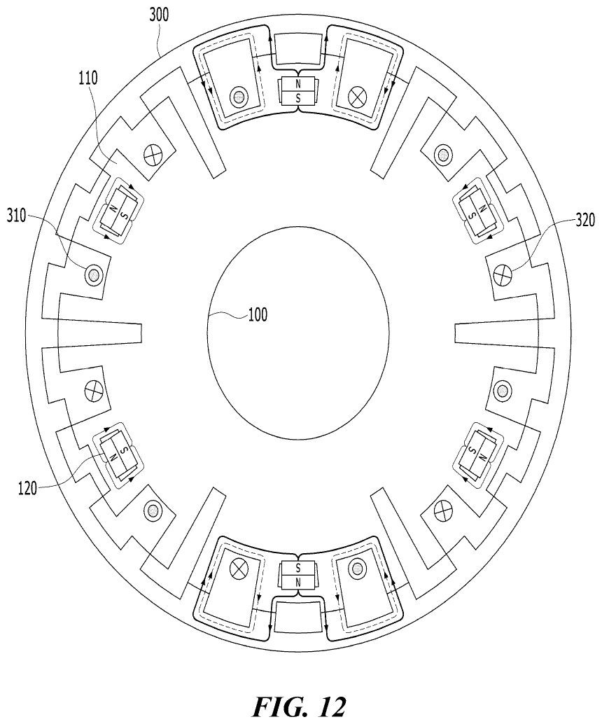

FIG. 12 is a plan view showing a magnetic field formed throughout the switched reluctance motor in which the rotor is located outside the stator when current is applied to the excitation module according to an exemplary embodiment of the present disclosure.

As in the exemplary embodiment where the rotor 300 is located inside the stator 100, the magnetic force lines emanating from the N pole of the permanent magnet module included in the excitation module of the stator 100 are formed such that, when current is applied, the induced magnetic field generated by the applied current and the magnetic field of the permanent magnet repel each other due to the repulsive force between the same poles, thereby forcibly pushing magnetic force lines into the air gap, causing them to turn around the rotor pole and return the S pole, and that, when no current is applied, they directly enter the S pole inside the stator along the magnetic flux path guide of the permanent magnet.

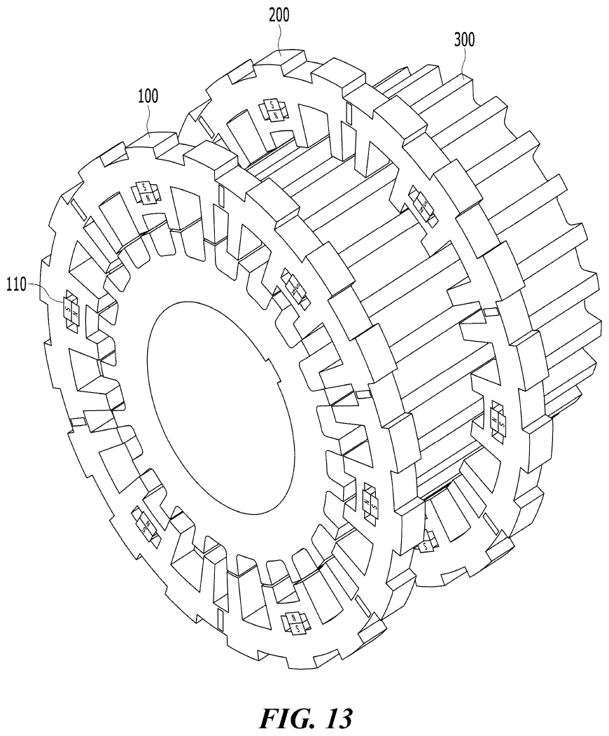

FIG. 13 is a three-dimensional view of a switched reluctance motor including a plurality of stators according to an exemplary embodiment of the present disclosure.

A switched reluctance motor of the present disclosure may be configured to include a plurality of stators and single rotor, rather than a single stator and a single rotor. For example, the switched reluctance motor of the present disclosure may be implemented to include a first stator 100, a second stator 200, and a rotor 300. In this case, the switched reluctance motor may be controlled such that the current applied to each stator is different, and additionally, the switched reluctance motor may be controlled such that the direction of the torque applied to the rotor by the current applied to each stator is the same.

In the respective stators, different numbers of excitation modules may be included, the permanent magnet modules included in the excitation modules may be arranged in different forms, and the coils may be wound in different configurations.

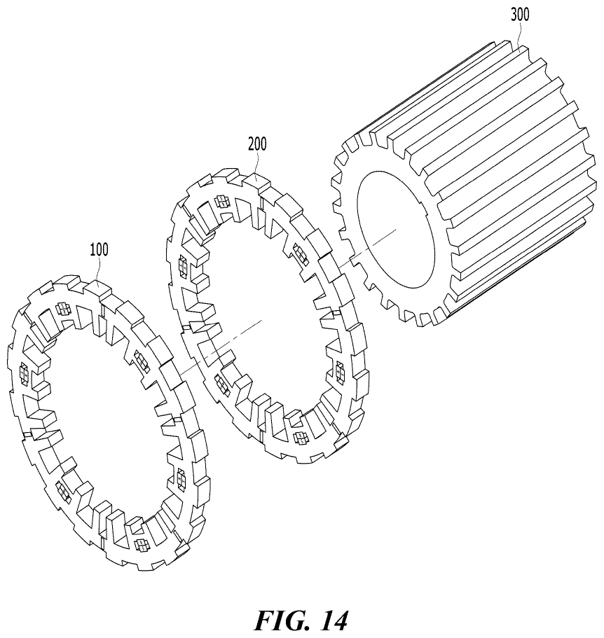

When a switched reluctance motor is configured with multiple stators and a rotor, as shown in FIG. 13, the torque applied to the rotor corresponds to the sum of torques generated by the respective stators. Therefore, when a switched reluctance motor is configured to include multiple stators, the output of the motor can be increased. An exemplary form of each component when the first stator 100, the second stator 200, and the rotor 300 are separated is shown in FIG. 14.

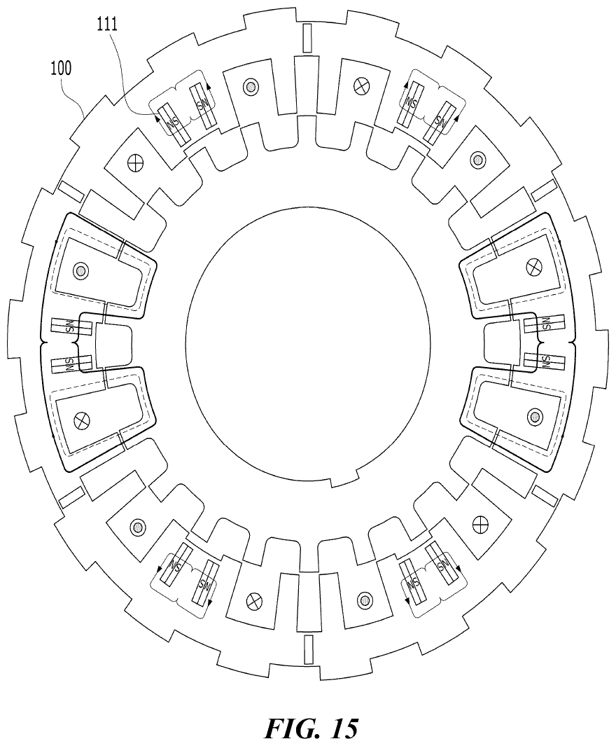

FIG. 15 is a plan view showing a magnetic field formed throughout a switched reluctance motor upon application of current to the switched reluctance motor and the excitation module when the permanent magnet module according to an exemplary embodiment of the present disclosure includes two permanent magnets.

The permanent magnet module 111 of the present disclosure may include two permanent magnets whose facing surfaces are of the same poles. As in the exemplary embodiment in which the permanent magnet module includes only one permanent magnet, the magnetic force lines emanating from the N poles of the respective permanent magnets constituting the permanent magnet module 111 are formed such that, when current is applied, the magnetic field of the permanent magnets is repelled by the induced magnetic field generated by the applied current due to the repulsive force between the same poles, thereby forcibly pushing the magnetic field lines into the air gap, causing them to turn around the rotor pole and return to the S pole, and that, when no current is applied, they directly enter the S pole inside the stator along the magnetic flux path guide of the permanent magnet module.

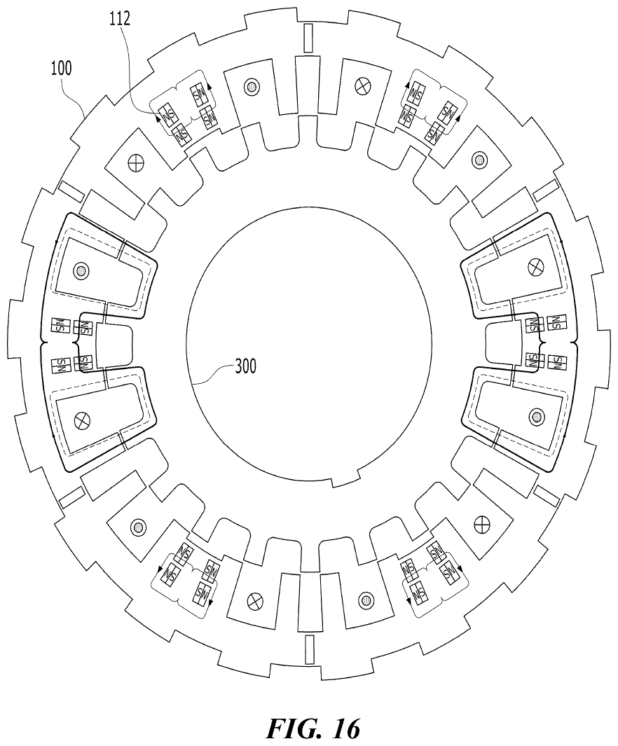

FIG. 16 is a plan view showing a magnetic field formed throughout a switched reluctance motor upon application of current to the switched reluctance motor and the excitation module when the permanent magnet module according to an exemplary embodiment of the present disclosure includes four permanent magnets.

The permanent magnet module 112 of the present disclosure may include four permanent magnets whose facing surfaces are of the same poles. As in the exemplary embodiment in which the permanent magnet module includes only one permanent magnet, the magnetic force lines emanating from the N poles of the respective permanent magnets constituting the permanent magnet module 112 are formed such that, when current is applied, the magnetic field of the permanent magnets is repelled by the induced magnetic field generated by the applied current due to the repulsive force between the same poles, thereby forcibly pushing the magnetic field lines into the air gap, causing them to turn around the rotor pole and return to the S pole. When no current is applied, the magnetic field of the permanent magnets is formed to directly enter the S pole inside the stator along the magnetic flux path guide.

In this way, the permanent magnet module included in the switched reluctance motor of the present disclosure may be implemented to include a plurality of permanent magnets, in addition to one permanent magnet, and the number of permanent magnets included in the permanent magnet module may vary depending on the size and design purpose of the motor.

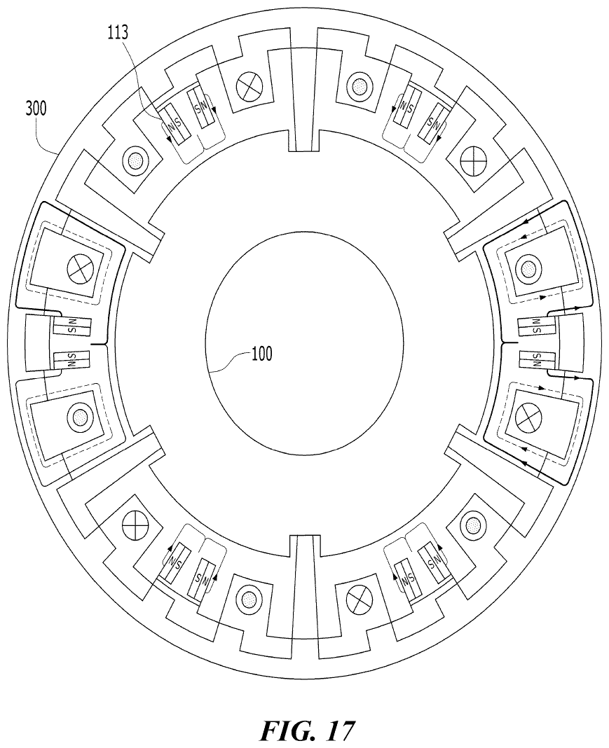

FIG. 17 is a plan view showing a magnetic field formed throughout a switched reluctance motor upon application of current to the switched reluctance motor, in which a rotor is located outside a stator, and the excitation module when the permanent magnet module according to an exemplary embodiment of the present disclosure includes two permanent magnets.

As in the exemplary embodiment in which the rotor 300 is present inside the stator 100, the permanent magnet modules included in the excitation module of the stator 100 may each include two permanent magnets. The magnetic field lines emanating from the N poles of the respective permanent magnets are formed such that, when current is applied, the magnetic field of the permanent magnets is repelled by the induced magnetic field generated by the applied current due to the repulsive force between the same poles, thereby forcibly pushing the magnetic field lines into the air gap, causing them to turn around the rotor pole and return to the S pole, and that, when no current is applied, the magnetic flux of the permanent magnets directly enters the S pole inside the stator along the magnetic flux path guide.

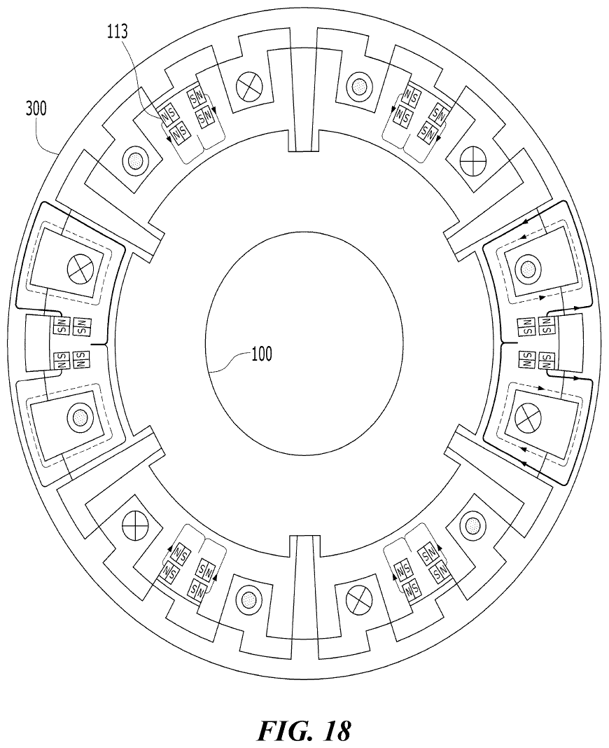

FIG. 18 is a plan view showing a magnetic field formed throughout a switched reluctance motor upon application of current to the switched reluctance motor, in which a rotor is located outside a stator, and the excitation module when the permanent magnet module according to an exemplary embodiment of the present disclosure includes four permanent magnets.

As in the exemplary embodiment in which the rotor 300 is present inside the stator 100, the permanent magnet modules included in the excitation module of the stator 100 may each include two permanent magnets. The magnetic field lines emanating from the N poles of the respective permanent magnets are formed such that, when current is applied, the magnetic field of the permanent magnet is repelled by the induced magnetic field generated by the applied current due to the repulsive force between the same poles, thereby forcibly pushing the magnetic field lines into the air gap, causing them to turn around the rotor pole and return to the S pole. When no current is applied, the magnetic fields of the permanent magnets are formed to directly enter the S pole inside the stator along the magnetic flux path guide.

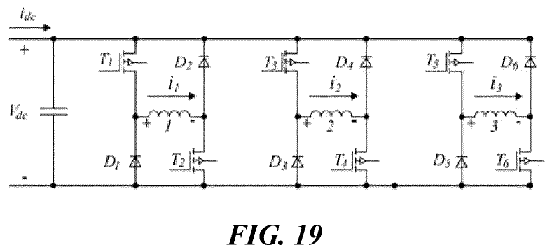

FIG. 19 is an exemplary circuit diagram of an asymmetric half-bridge converter for controlling a switched reluctance motor according to an exemplary embodiment of the present disclosure.

An asymmetric half-bridge converter may typically be configured by a semiconductor switch (usually a MOSFET or IGBT). This switch may serve to control the flow of current and control the operation of the converter.

In an exemplary embodiment of the present disclosure, the operation of the asymmetric half-bridge converter is largely divided into three modes: an excitation mode, a freewheeling mode, and a demagnetization mode. In a soft chopping control method, only one switch operates, which is more advantageous than a hard chopping control method in terms of current ripple, filter capacitor capacity, noise, and efficiency, and also lowers switching frequency. When using a fixed applied voltage, the switching frequency further decreases as the inductance increases. Current may be applied to the coil of the switched reluctance motor only during a portion of the operation period of the switched reluctance motor. During the period in which current is applied to the coil, a magnetic field is generated around the coil. This magnetic field may interact with the magnetic field generated by the permanent magnet module of the present disclosure, thereby applying torque to the rotor.

During a period in which no current is applied, no magnetic field due to current is generated around the coil, and the magnetic field generated by the permanent magnet module is also formed only around the permanent magnet module by the magnetic flux path guide of the permanent magnet. Therefore, the rotor is not affected by the magnetic field, and the cogging torque formed by the magnetic field during the operation of a switched reluctance motor of the related art is not generated.

The description of the presented embodiments has been provided to allow anyone skilled in the art to use or embody the present disclosure. It will be apparent to one skilled in the art that various modifications may be made to the embodiments, and general principles defined herein may be applied to other embodiments without departing from the scope of the present disclosure. Therefore, the present disclosure is not limited to the embodiments presented herein and should be interpreted as having the broadest possible range that is consistent with the principles and novel features presented herein.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A switched reluctance motor comprising:
a stator comprising a plurality of excitation modules; and
a rotor configured to rotate about a rotational axis by magnetically interacting with the stator,
wherein the excitation module comprises one or more permanent magnet modules configured to suppress cogging torque of the switched reluctance motor.

2. The switched reluctance motor of claim 1, wherein the rotor rotates about the rotational axis inside the stator.

3. The switched reluctance motor of claim 1, wherein each of the permanent magnet modules is located at a center of a coil wound around the excitation module, and comprises one or more permanent magnets, and one or more magnetic flux path guides coupled to the one or more permanent magnets.

4. The switched reluctance motor of claim 3, wherein the one or more permanent magnet modules are arranged at selected intervals along a circumferential direction of the stator.

5. The switched reluctance motor of claim 1, wherein the excitation module comprises:
a plurality of first salient poles arranged along a circumferential direction of the stator,
one or more first slots located between the plurality of first salient poles, and
a coil wound around the plurality of first salient poles.

6. The switched reluctance motor of claim 5, wherein an interval between the excitation modules is equal to a width of the first salient pole, and
wherein a width of the first slot is equal to or less than twice the width of the first salient pole.

7. The switched reluctance motor of claim 5, wherein the rotor comprises a plurality of second salient poles, and
wherein a width of the second salient pole is equal to or greater than a width of the first salient pole.

8. The switched reluctance motor of claim 5, wherein a current applied to the coil is a current applied in a direction in which a magnetic field induced by the current reinforces a magnetic field around the coil generated by the permanent magnet module.

9. The switched reluctance motor of claim 1, wherein the stator further comprises a flux barrier between the plurality of excitation modules.

10. The switched reluctance motor of claim 1, wherein the rotor rotates about the rotational axis outside the stator.

11. The switched reluctance motor of claim 1, wherein the stator comprises a plurality of stator modules having different phases, and
wherein the plurality of stator modules are located on the same rotational axis.

12. A motor structure comprising:
a stator comprising a plurality of excitation modules; and
a rotor configured to rotate about a rotational axis by magnetically interacting with the stator,
wherein the excitation module comprises one or more permanent magnet modules configured to suppress cogging torque of the motor structure.
